(19) United States
(12) Patent Application Publication
(10) Pub. No.: US 2002/0143968 A1
(43) Pub. Date: Oct. 3, 2002

(54) Insuring the proper return of queries requested by world wide web client stations from web sources when dynamic IP addresses are assigned to client stations

(75) Inventors: Dwip N. Banerjee, Austin, TX (US); Rabindranath Dutta, Austin, TX (US)

Correspondence Address: International Business Machines Corporation, Intellectual Property Law Department, Internal Zip 4054, 11400 Burnet Road, Austin, TX, 78758, US

(73) Assignee: International Business Machines Corporation, Armonk, NY

(21) Appl. No.: 09/821,120

(22) Filed: Mar. 29, 2001

(51) Int. Cl. G06F 15/16

(52) U.S. Cl. 709/230; 709/245

(57) ABSTRACT

An Internet system for the handling of query requests from a client station comprising a service provider supporting a set of said plurality of client stations. The provider has server means responsive to each query request from each of said set of client stations for temporarily assigning one of a set of IP addresses to each requesting client station and means for sending each query request to a Web server. The Web server includes means for determining if said assigned IP address is still assigned to said requesting client station in combination with means for sending a query response to said requesting client station only if said IP address is still assigned to said requesting station. The service server operates conventionally so that the means for assigning said IP addresses assigns an IP address to one requesting client station for only as long as the one requesting client station continues the query request according to DHCP protocols, i.e. there must be a discontinuance or disruption before dynamic reassignment can take place.

### TECHNICAL FIELD

The present invention relates to computer managed communication networks such as the World Wide Web (Web) and, particularly, to handling of Web client station query requests when using conventional TCP/IP (Transmission Control Protocol/Internet Protocol) protocols wherein dynamic IP addresses are temporarily assigned to the client station for each request transaction.

### BACKGROUND OF RELATED ART

The past decade has been marked by a technological revolution driven by the convergence of the data processing industry with the consumer electronics industry. The effect has, in turn, driven technologies which have been known and available but relatively quiescent over the years. A major one of these technologies is the Internet or Web related distribution of documents, media and files. The convergence of the electronic entertainment and consumer industries with data processing exponentially accelerated the demand for wide ranging communication distribution channels, and the Web or Internet, which had quietly existed for over a generation as a loose academic and government data distribution facility, reached “critical mass” and commenced a period of phenomenal expansion. With this expansion, businesses and consumers have direct access to all matter of documents and computer files. This rapid expansion has brought hundreds of millions of Web users at hundreds of millions of Web stations, i.e. client computer stations on the Web. In addition, Hypertext Markup Language (HTML), which had been the documentation language of the Internet or Web for years, offered direct links between Web pages. This even further exploded the use of the Internet or Web.

Web documents are provided from a Web distribution site or resource location usually made up of one or more network server computers which access the document (query) from a resource database in response to a user query request sent over the Web, usually through a Web browser on the user's receiving client computer station. Web distribution sites or resource locations usually serve large institutions such as corporations, universities, retail stores or governmental agencies. These distribution sites may also provide to smaller businesses or organizations support for and distribution of individual Web pages, created, owned and hosted by the individual small businesses and organizations. The network server computers that control the document and file distribution over the Web or Internet (terms are used interchangeably), include, in addition to servers which are at the resource locations, the servers of the Web Service Providers, e.g. cashing servers, through which the receiving client computer stations are connected into the Web, the Web servers which provide the client or user requested contents (query results) and through which the receiving client computer stations are connected into the Web, as well as resource servers at the other end that in turn connect the resource databases into the Web.

Conventional Web transactions use TCP/IP to move data or manage Web traffic. Data or content is moved in packets, each of which contains, in addition to its content, enough data to route the packet through to its destination. Web routers interpret the route data and move the packet to its destination address. The address is the numerical IP address. Each destination, e.g. Web client station must have such an IP address, either temporary or permanent in order for any Web transaction to be completed. Since such numerical addresses would be difficult to remember and are often temporary, each Web station has a unique domain name. There is a Domain Name System (DNS) for translating such numerical IP addresses into the Web site's domain name. Most of the access to the Web or Internet by the hundreds of millions of client users is through Internet or Web Service Providers that provide wired or wireless, usually dial-in, access to Provider servers that handle and transmit client query requests using TCP/IP protocols. Such service providers assign each client a new temporary IP address each time the client calls in, i.e. for each query request. This enables the service provider to get along with fewer IP addresses because the provider only needs enough IP addresses for the maximum number of clients who may be simultaneously dialed-in, i.e. actively requesting queries. This TCP/IP protocol is known as DHCP (Dynamic Host Configuration Protocol).

While protocols, such as DHCP, that assign temporary IP addresses have been very effective in minimizing the number of addresses which the service provider needs to inventory, the protocol has given rise to problems. Because of the very high volume of Web transactions that any given service provider must handle, IP addresses may be very rapidly reassigned after any interruption of contact with the requesting client. In most situations, an interruption or cut off by the requesting client, or the expiration of allotted time, e.g. lease time indicates that he has received his query response and the transaction is over. In such a case, the IP address may be reassigned without any problems.

However, problems may arise when the connection or contact with the client is cut off before the Web server to which the service provider has routed the query request has received the requested data and the query response has been returned to the IP address assigned to the client. If immediately after the initial client cut off the assigned IP address has been reassigned to another client, the Web server will then return the query response to the initial address which has now been reassigned to the new other client. This will be very confusing to the new client because the query response will have nothing to do with any query response that he may be expecting. In fact, in the present Internet climate with great exposure to malicious hacking, as well as various protective firewall protocols to protect against such hacking, the random or stray arrival of unrequested data may give rise to the suspicion of a malicious intrusion and trigger all manner of disruptions.

Unfortunately, unintended cut offs by clients that could lead to the above-described problem may be expected to be on the increase. With more and more inexperienced people trying to use the Web, there will be increased instances of the unsophisticated client switching on and off repeatedly to the service provider before waiting for responses to queries to play out and be returned. Also, with the great increase in pervasive, e.g. wireless “on-the-run”, access to the Web via Personal Digital Assistants (PDAs), palm computers and cellular phones, we can expect greater unintended cut offs since these devices are notoriously prone to such disruptions in service.

One solution has been to delay the reassignment of IP addresses for periods sufficient to eliminate the late arrival of query responses to reassigned IP addresses. However, with the current increase in Web usage, even simple delays in reassignment could result in an exponential increase in the number of IP addresses that a high activity service provider would have to inventory.

### SUMMARY OF THE PRESENT INVENTION

The present invention provides a solution to the problem of routing inappropriate earlier query responses to IP addresses which have already been reassigned. It does so without any increase in the number of IP addresses that a service provider would have to inventory for distribution under DHCP protocols. The invention provides an Internet system for the handling of query requests from a client station comprising a service provider supporting a set of said plurality of client stations. The provider has server means responsive to each query request from each of said set of client stations for assigning one of a set of IP addresses to each requesting client station and means for sending each query request to a Web server. The Web server includes means for determining if said assigned IP address is still assigned to said requesting client station in combination with means for sending a query response to said requesting client station only if said IP address is still assigned to said requesting station.

The service server operates conventionally so that the means for assigning said IP addresses assigns an IP address to one requesting client station for only as long as the one requesting client station continues the query request, i.e. there must be a discontinuance or disruption before dynamic reassignment can take place.

The requesting client station may be a wireless mobile station in which case there will be Web means for receiving a wireless query request from the mobile station within a limited range of transmission distance; but the mobile station is enabled to move out of said limited range to thereby discontinue said query request to give rise to the unintended disruption of service initiated IP address reassignment problems which the present invention solves.

In the preferred implementation of the invention, the service provider means further includes database means for recording the IP addresses dynamically assigned to client stations and the means in said Web server for determining if said assigned address is still assigned access to said database to make such a determination.

Thus, with the present invention, there are no circumstances wherein a query response to an interrupted query request from an earlier client station can be sent to an IP address reassigned to a subsequent client station. Quite simply stated, if the IP address made available for reassignment by the interruption of the original assigned client has not been reassigned, then a late query response will be attempted to the initially assigned address. Then, if the original client has re-established contact, it will receive the query response. If the original client has not established contact, there will be no active client at the address and the response will either be stored for the client or it will be discarded dependent upon the set up. On the other hand, if the IP address has been reassigned, no response will be made and, consequently, no confusion.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a block diagram of a data processing system including a central processing unit and network connections via a communications adapter which is capable of implementing the client stations, as well as the servers used by the service provider and Web servers in accordance with the present invention;

FIG. 2 is a generalized diagrammatic view of a World Wide Web portion upon which the present invention is implemented;

FIG. 3 is an illustrative flowchart describing the setting up of the elements needed for the program of the present invention for the dynamic reassignment of IP addresses without errant transmission of query responses to reassigned IP addresses resulting from unintended disruption of connections to clients to which IP addresses were originally assigned; and

FIG. 4 is a flowchart of an illustrative run of the program set up in FIG. 3.

### DETAILED DESCRIPTION OF THE PREFERRED EMBODIMENT

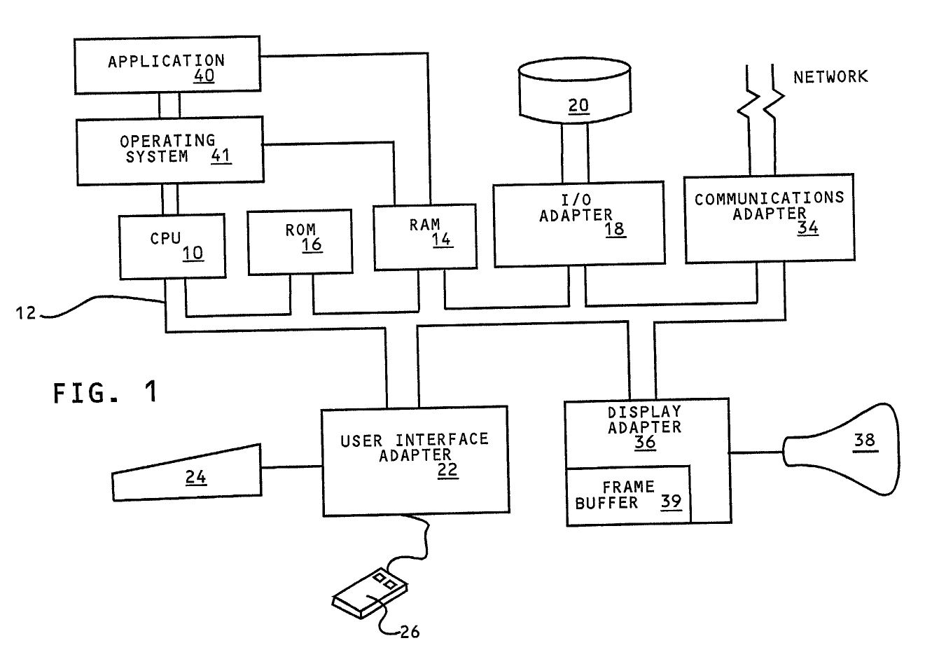

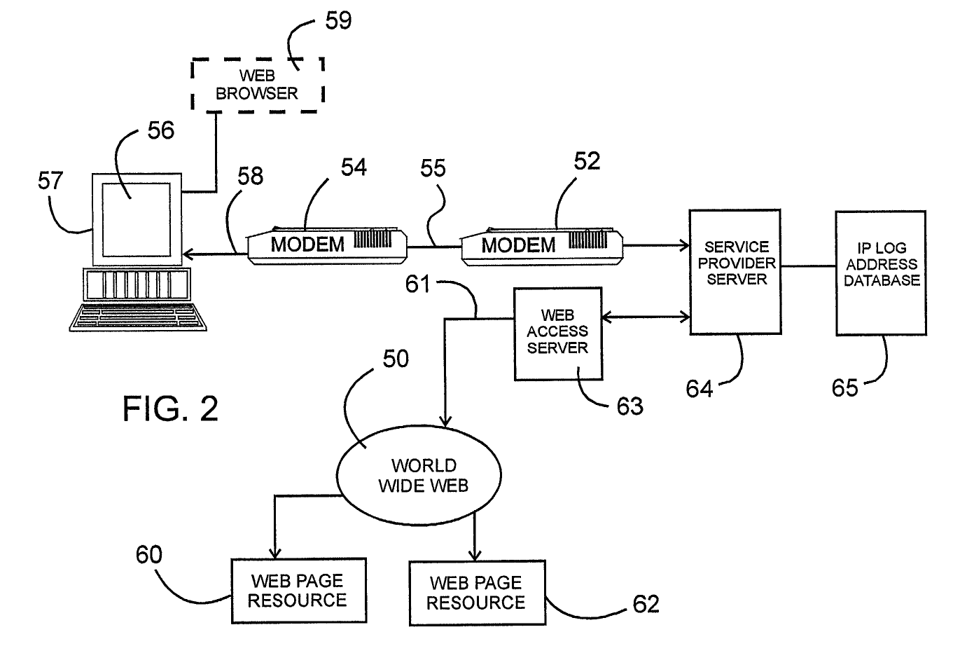

Referring to FIG. 1, a typical general data processing system is shown which may function as the client computer station, a server for the service provider or a Web server, the operation of which will be described in greater detail with respect to FIG. 2.

A Central Processing Unit (CPU) 10, such as one of the PC microprocessors or workstations, e.g. RISC System/6000(™) (RS/6000) series available from International Business Machines Corporation (IBM), is provided and interconnected to various other components by system bus 12. An operating system 41 runs on CPU 10, provides control and is used to coordinate the function of the various components of FIG. 1. Operating system 41 may be one of the commercially available operating systems such as the AIX 6000(™) operating system available from IBM; Microsoft's Windows98(™) or WindowsNT(™) as well as the UNIX and AIX operating systems. Application programs 40, controlled by the system, are moved into and out of the main memory Random Access Memory (RAM) 14. These programs include the programs used in the present invention for sending query requests, which are distributed through the service provider to various Web servers and for receiving query responses from these servers. These functions will be subsequently described in greater detail in combination with any conventional Web browser, such as the Netscape Navigator 3.0(™) or Microsoft's Internet Explorer(™). A Read Only Memory (ROM) 16 is connected to CPU 10 via bus 12 and includes the Basic Input/Output System (BIOS) that controls the basic computer functions. RAM 14, I/O adapter 18 and communications adapter 34 are also interconnected to system bus 12. I/O adapter 18 may be a Small Computer System Interface (SCSI) adapter that communicates with the disk storage device 20. Communications adapter 34 interconnects bus 12 with an outside network enabling the data processing system to communicate with other such systems over a Local Area Network (LAN) or a Wide Area Network (WAN), which includes, of course, the Web or Internet. I/O devices are also connected to system bus 12 via user interface adapter 22 and display adapter 36. Keyboard 24 and mouse 26 are all interconnected to bus 12 through user interface adapter 22. It is through such input devices that the user may interactively relate to Web documents, pages or files. Display adapter 36 includes a frame buffer 39, which is a storage device that holds a representation of each pixel on the display screen 38. Images may be stored in frame buffer 39 for display on monitor 38 through various components, such as a digital to analog converter (not shown) and the like. By using the aforementioned I/O devices, a user is capable of inputting information to the system through the keyboard 24 or mouse 26 and receiving output information from the system via display 38.

Before going further into the details of specific embodiments, it will be helpful to understand from a more general perspective the various elements and methods which may be related to the present invention. Since an aspect of the present invention is directed to Web query responses transmitting Web resource content that, would include documents, pages or files transmitted over the Web or Internet, an understanding of networks and their operating principles would be helpful. We will not go into great detail in describing the networks to which the present invention is applicable. For details on Web nodes, objects and links, reference is made to the text, Mastering the Internet, G. H. Cady et al., published by Sybex Inc., Alameda, Calif., 1996; or the text, Internet: The Complete Reference, Millennium Edition, Margaret Young et al., Osborne/McGraw-Hill, Berkeley, Calif., 1999.

Any data communication system that interconnects or links computer controlled systems with various sites defines a communications network. of course, the Internet or Web is a global network of a heterogeneous mix of computer technologies and operating systems. Higher level objects are linked to the lower level objects in the hierarchy through a variety of network server computers. These network servers are the key to network distribution, such as the distribution of Web pages and related documentation. Web documents are conventionally implemented in HTML language, which is described in detail in the text entitled Just Java, van der Linden, 1997, SunSoft Press, particularly at Chapter 7, pp. 249-268, dealing with the handling of Web pages; and also in the above-referenced Mastering the Internet, particularly pp. 637-642, on HTML in the formation of Web pages. In addition, aspects of this invention will involve Web browsers. A general and comprehensive description of browsers may be found in the above-mentioned Mastering the Internet text at pp. 291-313. More detailed browser descriptions may be found in the above-mentioned Internet: The Complete Reference, Millennium Edition, Chapter 19, pp. 419-454, on the Netscape Navigator; Chapter 20, pp. 455-494, on the Microsoft Internet Explorer; and Chapter 21, pp. 495-512, covering Lynx, Opera and other browsers.

A generalized diagram of a portion of the Web in which the computer controlled client display station 57 is used for receiving Web pages or documents using a Web browser 59 is connected as shown in FIG. 2. Client computer display station 57 with display 56 may be implemented by the computer system setup in FIG. 1 and connection 58 (FIG. 2) is the network connection shown in FIG. 1. Reference may be made to the above-mentioned Mastering the Internet, pp. 136-147, for typical connections between local display stations to the Web via network servers, any of which may be used to implement the system on which this invention is used. The system embodiment of FIG. 2 has a host-dial connection. Such host-dial connections have been in use for over 30 years. The connections are made through a service provider server 64 through Web servers 63 that are linked 61 to the Web 50. The Service Provider server 64 is accessed by the client station 57 through a normal dial-up telephone linkage 58 via modem 54, telephone line 55 and modem 52. The client station 57 makes its requests for data from the Web as query requests made to the Web access server 63 through the Service Provider server 64. Server 64 uses DHCP protocols that assigns each client a new temporary IP address each time the client calls in, i.e. for each query request. This enables the service provider to get along with fewer IP addresses because the provider only needs enough IP addresses for the maximum number of clients who may be simultaneously dialed-in, i.e. actively requesting queries.

The connection to Provider server 64 may also be made through wireless modems, described, for example, at pages 148 and 149 of the text, Palm III & Palm Pilot, Jeff Carlson, Peachpit Press, 1998. In present technology, wireless client stations thus connected to the Web are often mobile and, thus, pervasive. These terminals, also known as PDAs. include for example, Motorola's Two-Way Pager/PDA, the 3Com PalmPilot(™) and IBM's WorkPad(™). Current estimates are that there are more than fifteen million of these devices in present usage.

Query responses that are likely to include Web documents are accessed through Web server 63 via the Web 50 and Web data resources 60 and 62, and returned or downloaded back to client station 57 via the same telephone line linkages from server 63. As mentioned above, the present invention protects against a premature reassignment of an IP address by Service Provider server after an interruption in the connection with the initial client station 57 by maintaining an IP address log in database 65 which records the DNS names of all client stations that have currently been assigned IP addresses by server 64. Then, when Web server 63 has accessed the appropriate query response from the Web, server 63 checks log 65 to confirm that the original IP address is still assigned to client station, i.e. has not been reassigned. If the IP address has not been reassigned, then the server 63 goes ahead and routes the query response to the IP address and, consequently, the query request will reach client 57 provided there has not been any permanent interruption of contact with client 57. In any event, the query response will never be delivered inappropriately should the IP address have been reassigned.

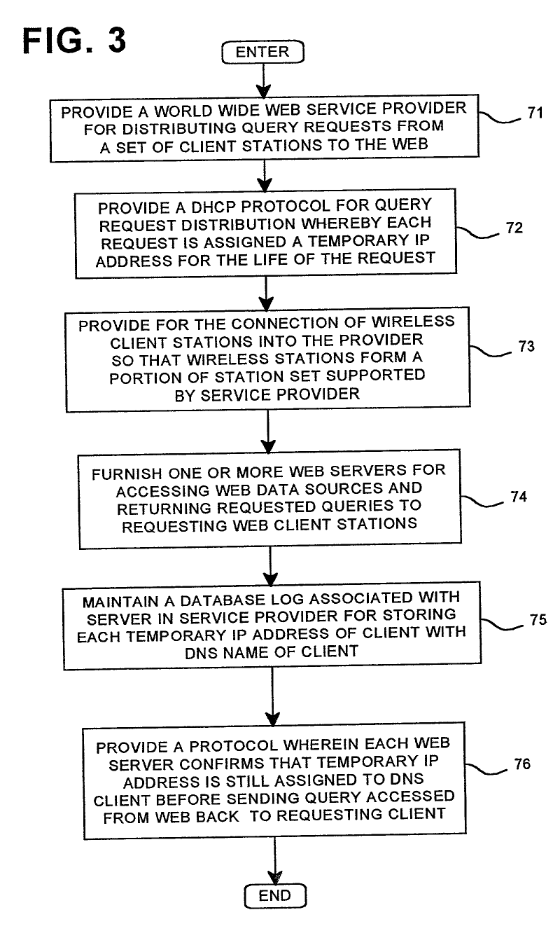

Now, with reference to the programming shown in FIG. 3, the program of the present invention is set up primarily in the Service Provider and in the Web server. A Service Provider is furnished for the distribution of query requests from any of a set of client stations on the Web, step 71. The Service Provider's server is provided with a DHCP protocol for query request distribution whereby each request is assigned a temporary IP address for the life of the request, i.e. so long as the request remains active and uninterrupted, step 72. There is also a provision for the connection of wireless client stations into the Web so that they may form wireless stations on the Web and remain part of the station set supported by the service provider, step 73. One or more Web servers are provided for access to and from data Web sources and for returning requested query results to requesting client stations, step 74. A database log is maintained associated with the service provider server for storing each temporary IP address of each client along with the DNS name of the client, step 75. There is provided a protocol wherein each Web server may confirm that the temporary IP address is still assigned to the DNS client and has not been reassigned before returning the query response to the requesting client, step 76.

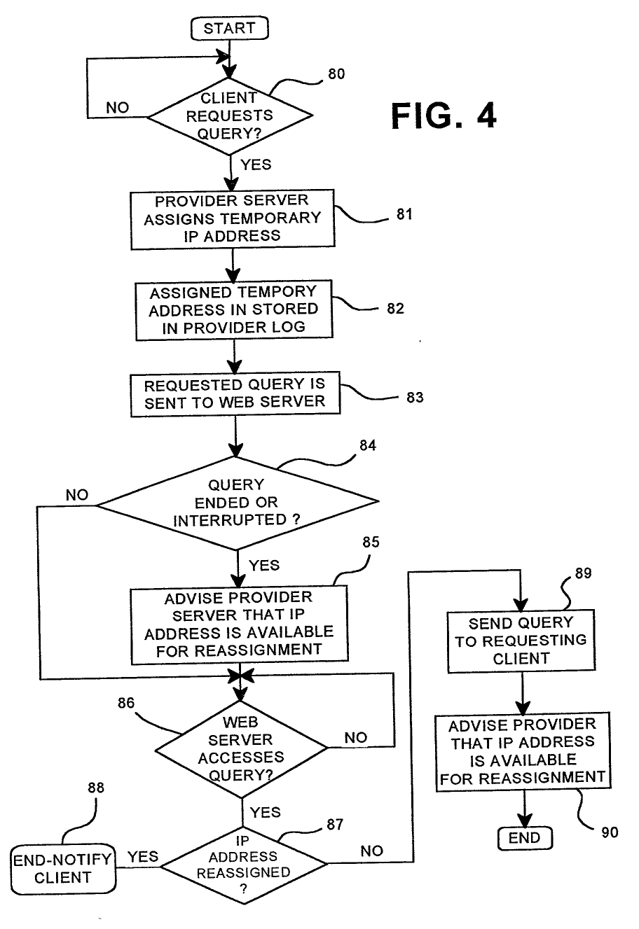

Now, with reference to the flowchart of FIG. 4, a simplified illustrative run of the process set up in FIG. 3 will be described. Let us assume that we are at a client station that is about to be activated. An initial determination is made as to whether the client has requested a query, step 80. If No, the process is returned to step 80 where a query request by the client is awaited. If Yes, a query has been requested, then, step 81, the server of the Service Provider assigns a temporary IP address in accordance with DHCP protocols and the assignment is recorded in a log in a database maintained by the Service Provider which correlates the IP address with the DNS name of the client, step 82. The requested query is transmitted to a Web server, step 83, which proceeds in its process of obtaining a query response from Web resources. During this process, the system is being monitored for any interruption or termination of connection, i.e. query, from the requesting client, step 84. If Yes, then the service provider is advised that the assigned IP address is available for reassignment, step 85. Irrespective of whether the client connection has been interrupted/ended, step 84, the Web server is still accessing the query response, as awaited in step 86. Where the determination in step 86 is Yes, the access of the query response has been completed, then the Web server checks the Service Provider log database to determine if the IP address has been reassigned, step 87. If Yes, the query is ended without response and the client may be advised appropriately of an error condition if he is available. If the decision in step 87 is No, the IP address has not been reassigned, then the query response is sent to the requesting client, step 89, and the Service Provider is advised that the IP address is available for reassignment, step 90.

It should be noted that the programs covered by the present invention may be stored outside of the present computer systems until they are required. The program instructions may be stored in another readable medium, e.g. in disk drive associated with the desktop computer or in a removable memory such as an optical disk for use in a CD ROM computer input, or in a floppy disk for use in a floppy disk drive computer input. Further, the program instructions may be stored in the memory of another computer prior to use in the system of the present invention and transmitted over a LAN or a WAN, such as the Internet, when required by the user of the present invention. One skilled in the art should appreciate that the processes controlling the present invention are capable of being distributed in the form of computer readable media of a variety of forms.

Although certain preferred embodiments have been shown and described involving the use of DHCP and DNS, it will be understood that many changes and modifications may be made therein without departing from the scope and intent of the appended claims.

1. In a World Wide Web (Web) communication network with user access via a plurality of data processor controlled client stations, a system for the handling of query requests from a client station comprising:
service provider means supporting a set of said plurality of client stations including:
means responsive to each query request from each of said set of client stations for assigning one of a set of IP addresses to each requesting client station, and
means for sending each query request to a Web server; and
a Web server comprising:
means for determining if said assigned IP address is still assigned to said requesting client station; and
means for sending a query response to said requesting client station only if said IP address is still assigned to said requesting station.

2. The Web query request handling system of claim 1 wherein said means for assigning said IP addresses assigns an IP address to one requesting client station for only as long as the one requesting client station continues the query request.

3. The Web query request handling system of claim 2 wherein said service provider means further includes means enabling the dynamic reassigning of an IP address to another requesting client station upon the discontinuance of a query request from one requesting client station.

4. The Web query request handling system of claim 3 wherein said one requesting client station is a wireless mobile station.

5. The Web query request handling system of claim 4 further including:
Web means for receiving a wireless query request from said mobile station within a limited range of transmission distance; and
wherein said mobile station is enabled to move out of said limited range to thereby discontinue said query request.

6. The Web query request handling system of claim 2 wherein:
said service provider means further includes database means for recording the IP addresses dynamically assigned to client stations; and
said means in said Web server for determining if said assigned address is still assigned access to said database.

7. In a Web communication network with user access via a plurality of data processor controlled client stations, a service provider supporting a set of said client stations, and a Web server for accessing and sending client station requested queries to said client stations, a method for the handling of query requests from a client station comprising:
assigning one of a set of IP addresses to each requesting client station responsive to each query request from each of said set of client stations;
sending each query request to a Web server;
determining by said Web server if said assigned IP address is still assigned to said requesting client station; and
sending a query result to said requesting client station only if said IP address is still assigned to said requesting station.

8. The Web query request handling method of claim 7 wherein said step of assigning said IP addresses assigns an IP address to one requesting client station for only as long as the one requesting client station continues the query request.

9. The Web query request handling method of claim 8 further including the step of enabling the dynamic reassigning of an IP address to another requesting client station by the service provider upon the discontinuance of a query request from one requesting client station.

10. The Web query request handling method of claim 9 wherein said one requesting client station is a wireless mobile station.

11. The Web query request handling method of claim 10 further including the steps of:
receiving a wireless query request from said mobile station within a limited range of transmission distance; and
enabling said wireless mobile station to move out of said limited range to thereby discontinue said query request.

12. The Web query request handling method of claim 8 further including the steps of:
recording the IP addresses dynamically assigned to client stations in a database at said service provider; and
whereby said step of determining if said assigned address is still assigned access to said database.

13. A computer program having code recorded on a computer readable medium for the handling of query requests from a client station in a Web communication network with user access via a plurality of data processor controlled client stations, a service provider supporting a set of said client stations, and a Web server for accessing and sending client station requested queries to said client stations, said program comprising:
means in said service provider supporting a set of said plurality of client stations including:
means responsive to each query request from each of said set of client stations for assigning one of a set of IP addresses to each requesting client station, and
means for sending each query request to a Web server;
means in said Web server for determining if said assigned IP address is still assigned to said requesting client station; and
means in said Web server for sending a query result to said requesting client station only if said IP address is still assigned to said requesting station.

14. The Web query request handling computer program of claim 13 wherein said means for assigning said IP addresses assign an IP address to one requesting client station for only as long as the one requesting client station continues the query request.

15. The Web query request handling program of claim 14 wherein said service provider means further includes means enabling the dynamic reassigning of an IP address to another requesting client station upon the discontinuance of a query request from one requesting client station.

16. The Web query request handling program of claim 15 wherein said one requesting client station is a wireless mobile station.

17. The Web query request handling program of claim 16 further including:
Web means for receiving a wireless query request from said mobile station within a limited range of transmission distance; and
wherein said mobile station is enabled to move out of said limited range to thereby discontinue said query request.

18. The Web query request handling program of claim 14 wherein:
said service provider means further includes database means for recording the IP addresses dynamically assigned to client stations; and
said means in said Web server for determining if said assigned address is still assigned access to said database.
